(19) United States
(12) Patent Application Publication
(10) Pub. No.: US 2004/0051318 A1
(43) Pub. Date: Mar. 18, 2004

(54) Starter

(75) Inventor: Masami Niimi, Handa-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 10/656,187

(22) Filed: Sep. 8, 2003

(30) Foreign Application Priority Data
Sep. 17, 2002 (JP) 2002-270041

(51) Int. Cl. F02N 11/00; F02N 15/06

(52) U.S. Cl. 290/38 R; 290/28

(57) ABSTRACT

A crank bar has a rod portion rotating in response to a magnetic force of an electromagnetic switch and an actuating arm formed at a distal end of the rod portion so as to swing about an axis of the rod portion when the rod portion rotates. A rotation restricting member is assembled with the actuating arm and is movable in a longitudinal direction of the actuating arm.

### BACKGROUND OF THE INVENTION

This invention relates to a starter having a rotation restricting mechanism for restricting the rotation of a pinion gear and pushing the pinion gear in the axial direction for engagement with a ring gear of an engine under the condition that the rotation of the pinion gear is restricted.

Increase of carbon dioxides in the air induces serious global warming problems and other related pollutions or destructions of global environments. To eliminate such problems, the automotive vehicles are strongly required to improve the fuel economy. To this end, a starter serving as one of accessories of the engine must reduce its weight.

For example, the U.S. Pat. No. 5,777,393 discloses a conventional starter which includes a pinion engaged with an output shaft via a helical spline coupling and a pinion rotation restricting member for restricting the rotation of the pinion. According to this conventional starter, the pinion shifts on the output shaft in the direction departing from a motor and meshes with a ring gear of the engine while rotation of the pinion is restricted by the pinion rotation restricting member.

According to the above conventional starter, no mechanism is required for directly utilizing a magnetic force generated from an electromagnetic switch to push the pinion toward the ring gear of the engine. Accordingly, it becomes possible to reduce the size of a solenoid to be incorporated in the electromagnetic switch. The magnetic force of the electromagnetic switch utilized by the above conventional starter is for actuating the pinion rotation restricting member. The force required for actuating the pinion rotation restricting member is fairly small compared with the force for pushing the pinion. This is the reason why the electromagnetic switch can be downsized. Accordingly, the starter can be downsized in structure and reduced in weight.

However, the pinion rotation restricting member used in the above conventional starter is constituted by a rigid spring rod member configured into a circular shape having a diameter larger than that of an outer diameter of the pinion. Thus, the pinion rotation restricting member has a relatively large mass and requires a special spring for returning the pinion rotation restricting member to its initial position after the engine has started. In other words, the pinion rotation restricting member having a large mass cannot be returned to its initial position by solely using a relatively weak spring incorporated in the electromagnetic switch (which is used for returning a plunger).

Accordingly, it is necessary to actuate the pinion rotation restricting member against a reaction force of the return spring in the engine startup operation. The magnetic force of the electromagnetic switch must be increased. As a result, the size of the solenoid becomes large. The electromagnetic switch cannot be downsized satisfactorily.

Furthermore, the above conventional starter has a structure for shifting the pinion rotation restricting member in a direction substantially normal to the rotational axis of the pinion rotation restricting member. Thus, an appropriate guide member is provided to guide the shift movement of the pinion rotation restricting member. The total number of constituent parts of the starter increases.

### SUMMARY OF THE INVENTION

In view of the above-described problems, the present invention has an object to provide a starter having a rotation restricting mechanism which is capable of reducing the total number of constituent parts and also capable of sufficiently reducing the size of an electromagnetic switch.

In order to accomplish the above and other related objects, the present invention provides a starter including a motor for generating a rotational force, a rotary output shaft being driven by the motor, an electromagnetic switch for ON/OFF controlling electric power supply to the motor, and a pinion shift member engaged with the rotary output shaft via a helical spline coupling so as to shift in an axial direction on the rotary output shaft. The pinion shift member has a pinion gear selectively engaging with a ring gear of an engine when the pinion shift member shifts in a direction departing from the motor. A rotation restricting member, having an engaging portion extending in a direction crossing with a rotational direction of the pinion shift member, restricts the rotation of the rotation restricting member by engaging with an engaging portion of the pinion shift member. An actuating means is provided for actuating the rotation restricting member by utilizing a magnetic force generated from the electromagnetic switch. According to the present invention, the actuating means has a rod portion rotating in response to the magnetic force of the electromagnetic switch and an actuating arm formed at a distal end of the rod portion so as to swing about an axis of the rod portion when the rod portion rotates. The rotation restricting member is assembled with the actuating arm and is movable together with the actuating arm.

According to the arrangement of the present invention, the rotation restricting member is assembled with the actuating arm so as to be movable together. The weight of the rotation restricting member is small. It is possible to return the rotation restricting member to the original position by using only the resilient force of the spring incorporated in the electromagnetic switch for returning the plunger to its initial position. No special spring is required for returning the rotation restricting member. Furthermore, no guide member is required for shifting the rotation restricting member. The costs for the constituent parts of the starter can be reduced. No special space for disposing the guide member is required. The starter can be sufficiently downsized.

Preferably, the rotation restricting member includes first and second bent portions which are substantially parallel to each other and have coupling holes through which the rotation restricting member is assembled with the actuating arm of the actuating means, and the engaging portion of the rotation restricting member is provided on the first bent portion. According to this arrangement, two bent portions can surely prevent the rotation restricting member from inclining when it restricts the rotation of the pinion shift member.

Preferably, the rotation restricting member is shiftable in a longitudinal direction of the actuating arm and is not rotatable about an axis of the actuating arm. According to this arrangement, when the pinion shift member is shifted in the direction departing from the motor to bring the pinion gear into engagement with the ring gear (especially, when the tooth traces of the pinion gear and the ring gear disagree), the rotation restricting member shifting in the longitudinal direction of the actuating arm allows the pinion shift member to rotate slightly until their tooth traces agree. Furthermore, as no relative rotation is caused between the rotation restricting member and the actuating arm, the rotation restricting member can surely restrict the rotation of the pinion shift member while giving a predetermined rotation restricting load.

Preferably, a stopper is provided on the actuating arm so as to be positioned between the first bent portion and the second bent portion, and a return spring is provided for resiliently urging the rotation restricting member. With this arrangement, the rotation restricting member itself needs not have a return spring function. The rotation restricting member can be configured into an optimum shape for restricting the rotation of the pinion shift member.

Preferably, the return spring is disposed between the stopper and the second bent portion to give a predetermined initial resilient force to the rotation restricting member when the first bent portion is brought into contact with the stopper. According to this arrangement, the return spring is disposed between the first bent portion and the second bent portion. It is not necessary to elongate the length of the actuating arm.

Furthermore, as the return spring gives the predetermined initial resilient force to the rotation restricting member, contact between the first bent portion and the stopper can be maintained with no play of the rotation restricting member in the longitudinal direction of the actuating arm. Thus, the rotation of the pinion shift member is surely restricted.

Preferably, the rotation restricting member is subjected, in its manufacturing process, to a heat treatment to assure a predetermined hardness for the engaging portion.

Preferably, the engaging portion of the pinion shift member has a plurality of recessed portions provided along its radially outer periphery. The engaging portion of the rotation restricting member enters into one of the recessed portions to restrict the rotation of the pinion shift member. And, the engaging portion of the rotation restricting member has at least one chamfered face for smoothly guiding the engagement between the rotation restricting member and the pinion shift member.

Preferably, the actuating means has a connecting means intervening between the rod portion and the actuating arm to detachably connect the rod portion and the actuating arm.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view showing the arrangement of a starter in accordance with a first embodiment of the present invention;

FIGS. 2A to 2C are views explaining operation of a rotation restricting member of the starter in accordance with the first embodiment of the present invention;

FIG. 3 is a perspective view showing the rotation restricting member and a crank bar of the starter in accordance with the first embodiment of the present invention;

FIG. 4 is an enlarged view showing a front end of an engaging portion of the rotation restricting member in accordance with the first embodiment of the present invention;

FIG. 5 is a diagram showing an electric circuit for the starter in accordance with the first embodiment of the present invention;

FIG. 6 is a front view of a pinion shift member and a rotation restricting member in accordance with a second embodiment of the present invention; and

FIG. 7 is a perspective view showing the rotation restricting member and a crank bar of the starter in accordance with the second embodiment of the present invention.

### DESCRIPTION OF THE PREFERRED EMBODIMENTS

Preferred embodiments of the present invention will be explained hereinafter with reference to attached drawings.

### First Embodiment

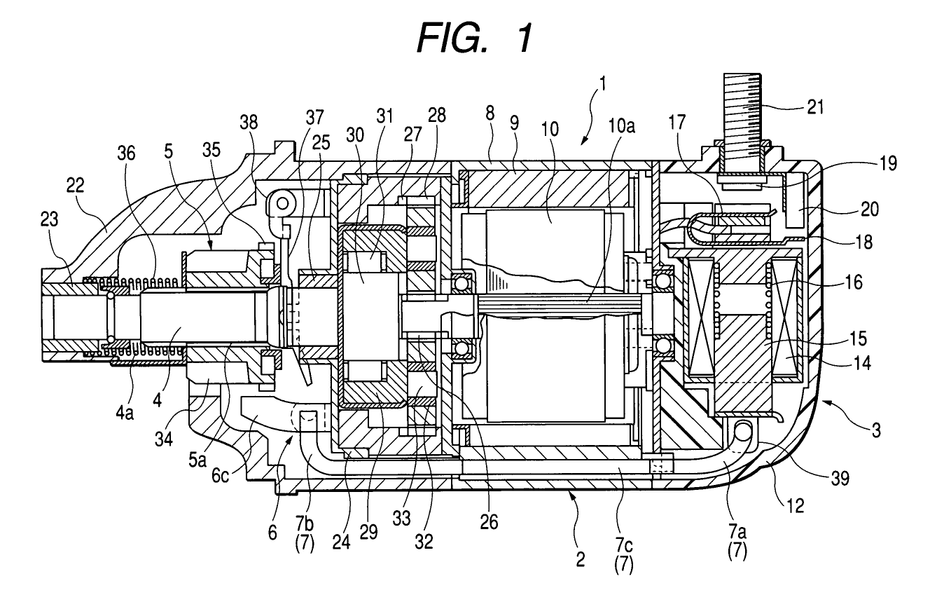

As shown in FIG. 1, a starter 1 of this embodiment of the present invention includes a motor 2 which generates a rotational force in response to supplied electric power. An electromagnetic switch 3 is provided for ON/OFF controlling electric power supplied to the motor 2. A rotary output shaft 4 is driven by the motor 2 and rotates about its axis. A sleeve-like pinion shift member 5 is slidably coupled around the cylindrical body of the output shaft 4. A rotation restricting member 6 is provided to restrict rotation of the pinion shift member 5 during an engine startup operation. A crank bar 7, serving as an actuating member, is provided to actuate the rotation restricting member 6 in response to a magnetic attraction force generated from the electromagnetic switch 3.

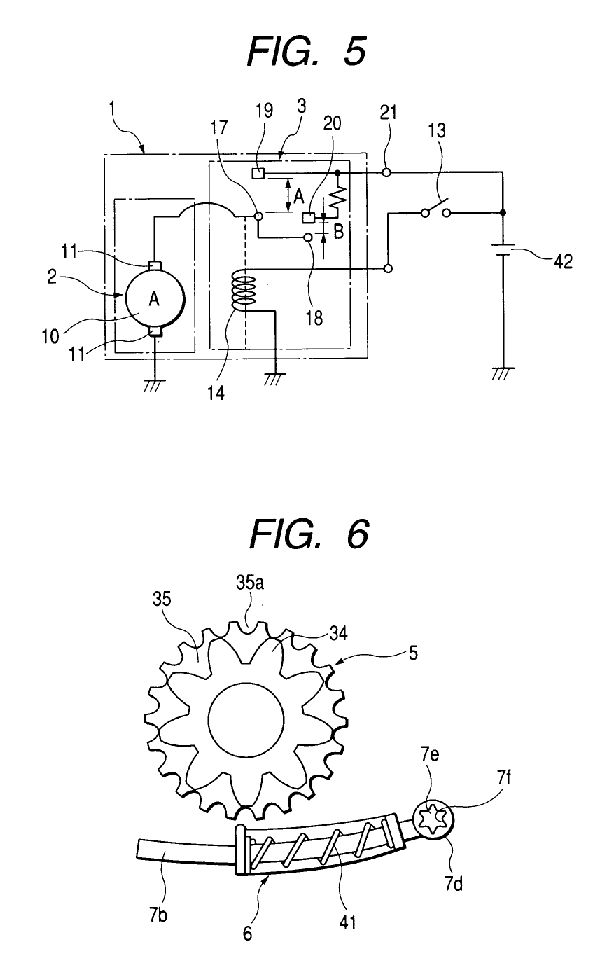

The motor 2 is a well-known direct-current motor including a yoke 8, a field magnet 9 (e.g., permanent magnet), an armature 10, and a brush 11 (refer to FIG. 5). When the motor contact (described below) incorporated in the electromagnetic switch 3 is closed, battery current flows via the brush 11 into the armature 10. The armature 10 causes a rotational force.

The electromagnetic switch 3 is disposed at a rear end of a starter body and covered by an end frame 12. The electromagnetic switch 3 includes a solenoid 14, a plunger 15, a spring 16, a pair of first and second movable contacts 17 and 18, and a pair of first and second stationary contacts 19 and 20. The solenoid 14 generates a magnetic force in response to ON operation of an ignition (IG) switch 13 (refer to FIG. 5). The plunger 15, disposed inside the solenoid 14, slides in the axial direction of the solenoid 14 in response to the magnetic force generated by the solenoid 14 when electric power is supplied to the solenoid 14. The spring 16, resiliently urging the plunger 15, returns the plunger 15 to its initial position when electric power supply to the solenoid 14 is stopped. The movable contacts 17 and 18 and the stationary contacts 19 and 20 cooperatively constitute motor contacts.

The first movable contact 17 is connected via a link member (not shown) to the plunger 15. The second movable contact 18 is mechanically and electrically connected to the first movable contact 17. Thus, each of the first and second movable contacts 17 and 18 moves together with the plunger 15. The second movable contact 18 is connected to the brush 11 serving as a positive-side brush. The first stationary contact 19 is disposed in a confronting relationship with the first movable contact 17. The second stationary contact 20 is disposed in a confronting relationship with the second movable contact 18. The first stationary contact 19 is integrally provided with a terminal bolt 21 fixed to the end frame 12. The second stationary contact 20 is mechanically and electrically connected to the first stationary contact 19 and fixed to the end frame 12.

The second stationary contact 20 is made of a carbon material having a higher electric resistance compared with the first stationary contact 19.

In the condition that the plunger 15 is stopped at its initial position (shown in FIG. 1), the relationship A>B is established when ‘A’ represents the distance between the first stationary contact 19 and the first movable contact 17, and ‘B’ represents the distance between the second stationary contact 20 and the second movable contact 18 (refer to FIG. 5).

Satisfying the above relationship is effective to suppress the rotational speed of the armature 10 to a lower level immediately after the motor 2 is started. More specifically, when electric power is supplied to the solenoid 14, the plunger 15 is magnetically attracted by the solenoid 14 and shifts upward in the illustration shown in FIG. 1. In this shift movement, the second movable contact 18 is brought into contact with the second stationary contact 20 earlier than the first movable contact 17 contacting with the first stationary contact 19. In this moment, current flows via the second stationary contact 20 having a higher electric resistance from a battery 42 to the armature 10. Due to a significant voltage drop at the second stationary contact 20, the voltage applied to the armature 10 is relatively small. Thus, the armature 10 rotates at relatively lower speeds. Thereafter, the first movable contact 17 is brought into contact with the first stationary contact 19. At this moment, all of the battery voltage (i.e., a rated voltage of the battery 42) is applied via the first stationary contact 19 to the armature 10. Thus, the armature 10 rotates at higher speeds.

The output shaft 4 is rotatably supported by a bearing 23 fixed to a front housing 22 and a bearing 25 fixed to a center plate 24. The output shaft 4 is connected to an armature shaft 10a (i.e., an output shaft) of the motor 2 via a speed-reduction device and a one-way clutch.

The speed-reduction device includes a sun gear 26 integrally formed at a distal end of the armature shaft 10a, an internal gear 27 fixed to the center plate 24, and a plurality of planetary gears 28 interposing between the sun gear 26 and the internal gear 27 so as to mesh with each of the sun gear 26 and the internal gear 27. When the sun gear 26 rotates, the planetary gears 28 cause an orbital motion about the sun gear 26. Thus, the sun gear 26, the internal gear 27, and the planetary gears 28 cooperatively constitute a planetary gear type speed-reduction device.

The one-way clutch includes an outer member 29 to which the orbital motion of the planetary gears 28 is transmitted and an inner member 30 disposed at a radially inner side of the outer member 29. Furthermore, the one-way clutch includes rollers 31 disposed in wedge-shaped spaces formed between the outer member 29 and the inner member 30.

A predetermined number of support pins 33 are press-fitted into the outer member 29. Each planetary gear 28 is rotatably supported via a bearing 32 by a corresponding support pin 33. When the planetary gears 28 cause the orbital motion about the sun gear 26, the orbital motion of planetary gears 28 is transmitted via the support pins 33 to the outer member 29. Thus, the outer member 29 rotates at a reduced speed in response to the rotation of the armature shaft 10a.

The inner member 30, provided at a rear end of the output shaft 4, rotates integrally with the output shaft 4. The rollers 31, when the outer member 29 rotates in response to the orbital motion of the planetary gears 28, are locked between the outer member 29 and the inner member 30. The rotation of the outer member 29 is transmitted via the rollers 31 to the inner member 30. On the other hand, when the rotational speed of inner member 30 exceeds the rotational speed of outer member 29 after the engine is started up, the rollers 31 are unlocked from the outer member 29 and the inner member 30. The outer member 29 and the inner member 30 cause slip, and no driving power is transmitted from the outer member 29 to the inner member 30.

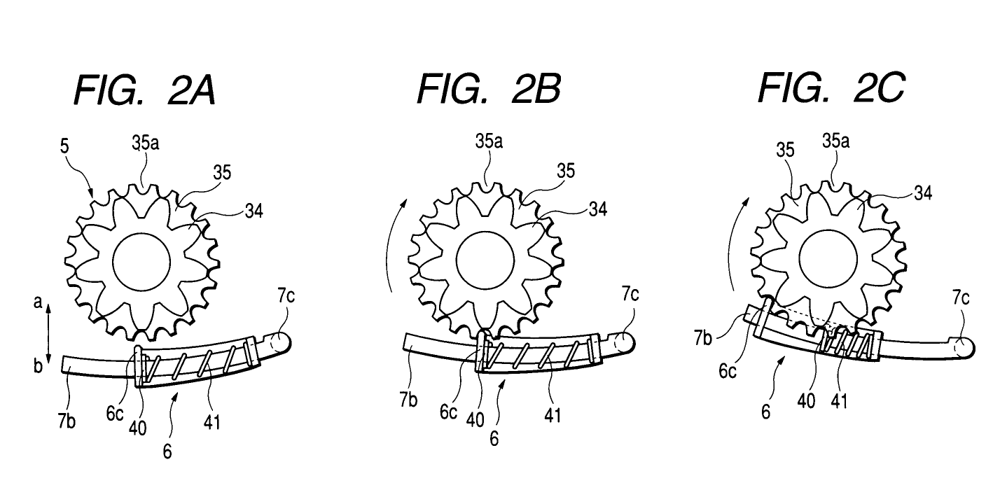

The pinion shift member 5 includes a pinion gear 34 meshing with a ring gear (not shown) of the engine during a startup operation of the engine and a flange portion 35 (serving as an engaging portion) provided at a rear side closer to the speed-reduction device. An internal helical spline 5a is formed on an inner cylindrical surface of the pinion shift member 5. The internal helical spline 5a meshes with an external helical spline 4a formed on an outer cylindrical surface of the output shaft 4. Thus, the pinion shift member 5 slides in the axial direction of the output shaft 4 and is coupled around the output shaft 4 via the helical spline engagement so as not to cause a relative rotation. A spring 36 resiliently urges the pinion shift member 5 toward the speed-reduction device. As shown in FIG. 2, a large number of recessed portions 35a are formed along a radially outer periphery of the flange portion 35.

The pinion shift member 5 holds a detent member 37 which cooperates with the rotation restricting member 6 for preventing the pinion shift member 5 from returning toward the speed-reduction device after the pinion gear 34 has meshed with the ring gear. The detent member 37 has one end swinging about a hook 38 fixed to the center plate 24. An intermediate portion of the detent member 37 is swingably held by a holder (not shown) provided at a rear end surface of the pinion shift member 5.

The crank bar 7, being constituted for example by a single metal rod, has a connecting portion 7a engaged with a hook portion 39 provided on the plunger 15 of the electromagnetic switch 3, an actuating arm 7b assembled with the rotation restricting member 6, and a rod portion 7c extending from the connecting portion 7a to the actuating arm 7b. The connecting portion 7a, being formed by bending one end of the metal bar perpendicularly, is rotatably inserted into a through-hole of the hook portion 39. The rod portion 7c passes a clearance of the field magnet 9 (for example, a space between two adjacent magnets disposed in the circumferential direction) in parallel with an axial direction of the motor 2. A bearing (not shown) supports the rod portion 7c so as to rotate about its axis.

The actuating arm 7b is formed by bending the other end of the metal bar perpendicular and is positioned just beyond the center plate 24. As shown in FIG. 2B, the actuating arm 7b is disposed adjacently to the radially outer periphery of the flange portion 35 provided on the pinion shift member 5. The actuating arm 7b extends in a direction crossing with the axial direction of the pinion shift member 5. The crank bar 7 rotates about its axis when the shift movement of the plunger 15 (i.e., up-and-down shift movement in FIG. 1) is transmitted to the rod portion 7c via the connecting portion 7a. As a result, the actuating arm 7b swings about an axis of the rod portion 7c as indicated by an arrow shown in FIG. 2A,

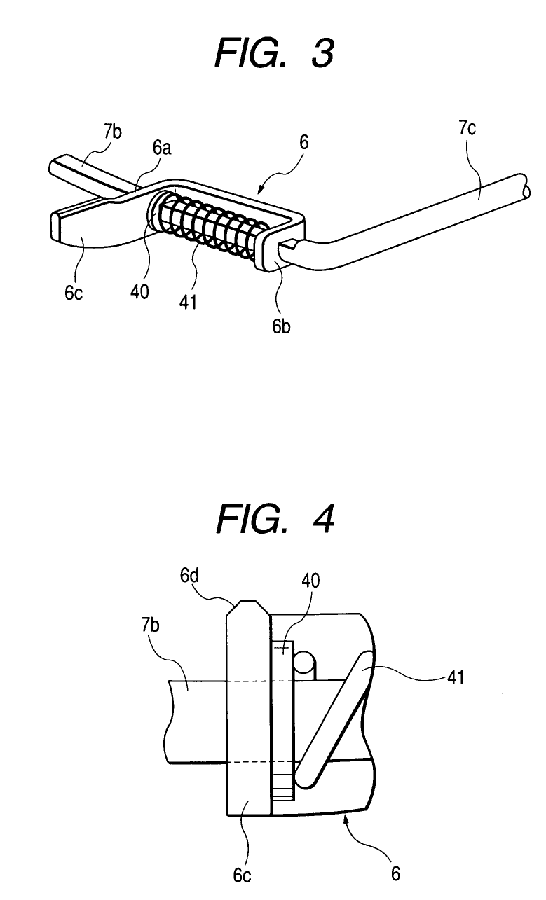

The rotation restricting member 6, as shown in FIG. 3, is formed by bending a plate member into a U-shaped configuration. The actuating arm 7b is assembled with the rotation restricting member 6. More specifically, the rotation restricting member 6 includes a first bent portion 6a and a second bent portion 6c being substantially parallel to each other and having coupling holes through which the rotation restricting member 6 is swingably supported by the actuating arm 7b of the crank bar 7. The cross-sectional shape of the actuating arm 7b and the cross-sectional shape of the coupling holes of first and second bent portions 6a and 6c are D shape or any other modified shape, so that no relative rotation is caused between the rotation restricting member 6 and the actuating arm 7b.

An engaging portion 6c is integrally formed with the first bent portion 6a of the rotation restricting member 6. When the actuating arm 7b shifts toward the pinion shift member 5 (i.e., in the direction indicated by the arrow ‘a’ in FIG. 2A), the engaging portion 6c engages with one of the recessed portions 35a formed on the flange portion 35 so as to prevent the pinion shift member 5 from rotating.

The engaging portion 6c, as shown in FIG. 1, is disposed along the axial direction of the pinion shift member 5 so as to have a predetermined longitudinal length. As shown in FIG. 4, chamfered faces 6d are formed at one end of the engaging portion 6c to smoothly guide the engagement between the rotation restricting member 6 and the flange portion 35.

In its manufacturing processes, the rotation restricting member 6 having the engaging portion 6c is subjected to a heat treatment (e.g., induction hardening) to assure a predetermined hardness for the engaging portion 6c.

A stopper 40 is provided on the actuating arm 7b so as to be positioned between the first bent portion 6a and the second bent portion 6b. The first bent portion 6a is brought into contact with the stopper 40 at an in initial position. From this initial condition, the first bent portion 6a is freely shiftable toward the distal end of the actuating arm 7b. On the other hand, the first bent portion 6a is stopped by the stopper 40 when it moves toward the rod portion 7c. A return spring 41 is interposed between the stopper 40 and the second bent portion 6b. The return spring 41 resiliently urges the second bent portion 6b of rotation restricting member 6. In other words, the return spring is disposed between the stopper 40 and the second bent portion 6b to give a predetermined initial resilient force to the rotation restricting member 6 when the first bent portion 6a is brought into contact with the stopper 40.

The above-described starter operates in the following manner.

When the IG switch 13 is closed (i.e., turned on), electric power is supplied from the battery 42 to the solenoid 14 of electromagnetic switch 3. The solenoid 14 generates a magnetic field, and accordingly the plunger 15 is drawn upward in FIG. 1. The shift movement of the plunger 15 is transmitted to the rotation restricting member 6 via the crank bar 7. The rotation restricting member 6 shifts upward in FIG. 1. As shown in FIG. 2B, the engaging portion 6c of the rotation restricting member 6 engages with the recessed portion 35 of flange portion 35. Thus, the pinion shift member 5 is locked (i.e., restricted so as not to be rotated) by the rotation restricting member 6.

On the other hand, in accordance with a shift movement of the plunger 15, the second movable contact 18 in the electromagnetic switch 3 is brought into contact with the second stationary contact 20 earlier than the contact timing of the first movable contact 17. A relatively small current flows from the battery 42 to the armature 10. The armature 10 rotates at lower speeds. The rotational speed of armature 10 is reduced by the speed-reduction device and is transmitted via the one-way clutch to the output shaft 4. While the output shaft 4 is rotating, the pinion shift member 5 is locked by the rotation restricting member 6. Thus, the rotation force of output shaft 4 is transmitted as a thrust force via the helical spline coupling to the pinion shift member 5.

Accordingly, the pinion shift member 5 shifts forward on the output shaft 4 until an end surface of the pinion gear 34 is brought into contact with the ring gear of the engine. The pinion gear 34 will not be able to engage with the ring gear if their tooth traces disagree. In this case, the pinion shift member 5 cannot advance forward. Under this stalling condition, the rotational force of output shaft 4 is not converted into a thrust force of the pinion shift member 5. Accordingly, a rotational force is given to the pinion shift member 5.

At this moment, rotation of the pinion shift member 5 is restricted by the rotation restricting member 6. However, the rotational force given to the pinion shift member 5 is larger than a resilient force of the return spring 41. The pinion shift member 5, overcoming the resilient force of the return spring 41, starts rotating under the condition that the engaging portion 6c of rotation restricting member 6 is engaged with the recessed portion 35a of the flange portion 35. In response to the rotation of pinion shift member 5, the rotation restricting member 6 shifts toward the distal end of the actuating arm 7b while it deforms the return spring 41 as shown in FIG. 2C.

While the pinion shift member 5 rotates by an amount corresponding to one pitch of the pinion gear 34, the pinion gear 34 can mesh with the ring gear when their tooth traces agree. Thus, the pinion shift member 5 advances again on the output shaft 4 under the given thrust force. The pinion gear 34 can mesh with the ring gear soon.

Once the pinion gear 34 completely meshes with the ring gear of the engine, the engaging portion 6c of rotation restricting member 6 is disengaged from the recessed portion 35a of the flange portion 3. The rotation restricting member 6 is pushed back by the resilient force of the return spring 41, and returns to its initial position along the actuating arm 7b. Furthermore, the rotation restricting member 6 enters behind a rear end of the detent member 37 which is disposed at the rear side of the pinion shift member 5. Thus, the rearward movement of the pinion shift member 5 along the output shaft 4 is prevented by the detent member 37.

The detent member 37 swings about its one end being supported by the hook 38 in accordance with the forward movement of the pinion shift member 5. The lower end of the detent member 37 is disposed closely to the rear end surface of the pinion shift member 5.

When the IG switch 13 is opened (i.e., turned off) after succeeding the engine startup operation, no electric power is supplied to the solenoid 14 of electromagnetic switch 3. The solenoid 14 generates no magnetic force. The plunger 15 is resiliently pushed down by the spring 16 and returns to its initial position. In accordance with the shift movement of the plunger 15, the rod portion 7c of crank bar 7 rotates in the opposite direction and accordingly the actuating arm 7b rotates about the axis of rod portion 7c and returns to its initial position as indicated by an arrow b shown in FIG. 2A.

As a result of the above return movement of the crank bar 7, the engaging portion 6c of the rotation restricting member 6 is released from the detent member 37. The pinion shift member 5 is unlocked from the detent member 37 and shifts rearward on the output shaft 4 under the resilient force acting from the spring 36 and a pushing force acting from the ring gear. Thus, the pinion shift member 5 returns to a stationary position shown in FIG. 1.

According to the starter 1 of this embodiment, the rotation restricting member 6 restricting the rotation of the pinion shift member 5 is assembled with the actuating arm 7b of crank bar 7. The rotation restricting member 6 is movable together with the actuating arm 7b. The rotation restricting member 6 is compact is size and light in weight. The resilient force of the spring 16 incorporated in the electromagnetic switch 3 can be utilized for returning the rotation restricting member 6 to the original position. Namely, the rotation restricting member 6 has a relatively small mass, and the operation of the crank bar 7 is represented by a rotational motion about the rod portion 7c. The operation force required to operate the crank bar 7 is small.

Thus, it is possible to return the rotation restricting member 6 to the original position by using only a reaction force of the spring 16 incorporated in the electromagnetic switch 3. It is not necessary to use a dedicated or special return spring. It is thus unnecessary to move the rotation restricting member 6 against the reaction force of the dedicated spring in restricting the rotation of the pinion shift member 5 during the engine startup operation. It becomes possible to reduce a magnetic attraction force of the electromagnetic switch 3. As a result, the solenoid 14 can be downsized. The electromagnetic switch 3 can be downsized, too.

Furthermore, no guide member is required for guiding the shift movement of the rotation restricting member 6 because the rotation restricting member 6 is movable together with the actuating arm 7b. The total costs of constituent parts of the starter 1 can be decreased. No space is required for installing the guide member. The starter 1 can be downsized.

Furthermore, the rotation restricting member 6 has the first bent portion 6a and the second bent portion 6b via which the actuating arm 7b is supported. In restricting the rotation of the pinion shift member 5, two bent portions 6a and 6b can surely prevent the rotation restricting member 6 from inclining. Thus, the rotation of the pinion shift member 5 can be surely prevented.

### Second Embodiment

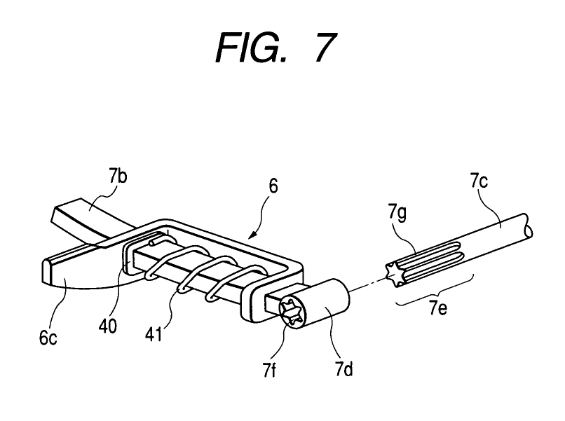

FIG. 7 is a perspective view showing a rotation restricting member 6 and a crank bar 7 in accordance with a second embodiment of the present invention. According to this embodiment, a rod portion 7c of the crank bar 7 is separated from an actuating arm 7b.

The actuating arm 7b has a female joint 7d formed at its end, while the rod portion 7c has a male joint 7e formed at its end. The female joint 7d and the male joint 7e are detachably engaged with each other so as to constitute a connecting means.

The female joint 7d has a cylindrical sleeve-like shape having a plurality of axially-extending engaging grooves 7f formed on an inner cylindrical surface. The male joint 7e is composed of a plurality of axially-extending engaging protrusions 7g formed on an outer cylindrical surface of the rod portion 7c. When the male joint 7e is inserted into the female joint 7d, the engaging protrusions 7g mate with the engaging grooves 7f so as to cause no relative rotation therebetween (refer to FIG. 6).

According to this embodiment, the male joint 7e is formed on the straight end portion of the rod portion 7c. In the assembling processes of the starter 1, it is unnecessary to bend the rod portion 7c. It is also unnecessary to use a predetermined fixing member after the connecting portion 7a of crank bar 7 is inserted into the hook portion 39 in the final step of installing the solenoid 14 of electromagnetic switch 3. Thus, it becomes possible to employ a simple assembling method according to which the constituent parts are successively and easily assembled on the front housing 22.

What is claimed is:

1. A starter comprising:
a motor for generating a rotational force;
a rotary output shaft being driven by said motor;
an electromagnetic switch for ON/OFF controlling electric power supply to said motor;
a pinion shift member engaged with said rotary output shaft via a helical spline coupling so as to shift in an axial direction on said rotary output shaft, with a pinion gear selectively engaging with a ring gear of an engine when said pinion shift member shifts in a direction departing from said motor;
a rotation restricting member having an engaging portion extending in a direction crossing with a rotational direction of said pinion shift member, for restricting the rotation of said rotation restricting member by engaging with an engaging portion of said pinion shift member; and
an actuating means for actuating said rotation restricting member by utilizing a magnetic force generated from said electromagnetic switch,
wherein said actuating means has a rod portion rotating in response to the magnetic force of said electromagnetic switch and an actuating arm formed at a distal end of said rod portion so as to swing about an axis of said rod portion when said rod portion rotates, and
said rotation restricting member is assembled with said actuating arm and is movable together with said actuating arm.

2. The starter in accordance with claim 1, wherein said rotation restricting member includes a first bent portion and a second bent portion which are substantially parallel to each other and have coupling holes through which said rotation restricting member is assembled with said actuating arm of said actuating means, and said engaging portion of said rotation restricting member is provided on said first bent portion.

3. The starter in accordance with claim 2, wherein said rotation restricting member is shiftable in a longitudinal direction of said actuating arm and is not rotatable about an axis of said actuating arm.

4. The starter in accordance with claim 3, wherein a stopper is provided on said actuating arm so as to be positioned between said first bent portion and said second bent portion, and a return spring is provided for resiliently urging said rotation restricting member.

5. The starter in accordance with claim 4, wherein said return spring is disposed between said stopper and said second bent portion to give a predetermined initial resilient force to said rotation restricting member when said first bent portion is brought into contact with said stopper.

6. The starter in accordance with claim 1, wherein said rotation restricting member is subjected, in its manufacturing process, to a heat treatment to assure a predetermined hardness for said engaging portion.

7. The starter in accordance with claim 1, wherein said engaging portion of said pinion shift member has a plurality of recessed portions provided along its radially outer periphery, and said engaging portion of said rotation restricting member enters into one of said recessed portions to restrict the rotation of said pinion shift member, and said engaging portion of said rotation restricting member has at least one chamfered face for smoothly guiding the engagement between said rotation restricting member and said pinion shift member.

8. The starter in accordance with claim 1, wherein said actuating means has a connecting means intervening between said rod portion and said actuating arm to detachably connect said rod portion and said actuating arm.
